(19) United States
(12) Patent Application Publication
(10) Pub. No.: US 2003/0151799 A1
(43) Pub. Date: Aug. 14, 2003

(54) Gain control in wavelength switched optical networks

(75) Inventors: Mark Stephen Wight, Ottawa (CA); Kevan Peter Jones, Kanata (CA); Aihua Yu, Ottawa (CA); Alan Glen Solheim, Stittsville (CA); Clarence Kwok-Yan Kan, Bridgewater, NJ (US); Josh Paul Kemp, Kanata (CA); Christian Scheerer, Ottawa (CA)

Correspondence Address: Norman P. Soloway, HAYES SOLOWAY P.C., 130 W. Cushing Street, Tucson, AZ, 85701, US

(73) Assignee: Innovance, Inc.

(21) Appl. No.: 10/329,067

(22) Filed: Dec. 24, 2002

Related U.S. Application Data
(63) Continuation-in-part of application No. 09/975,362, filed on Oct. 11, 2001.

(51) Int. Cl. H01S 3/00

(52) U.S. Cl. 359/334; 359/341.3

(57) ABSTRACT

A Raman module comprises a detecting unit for measuring the output power of a WDM signal traveling along a fiber section, and a spectral gain estimating unit for determining an estimated vector gain Gainₘₑₐₛ based on the output power alone. The Raman pump signal is controlled with a gain Gain_{RA} evaluated based on the estimated gain Gainₘₑₐₛ so that all channels have a similar gain. The spectral gain estimating unit comprises a fiber gain model and an input signal adjust unit. The model receives the output power, assumes a predicted input power for each channel and provides a corresponding estimated output power for each channel. The input signal adjust unit adjusts the predicted input power based on an error signal provided by the model. The gain is then calculated from the predicted input powers and the estimated output powers. The detecting unit demultiplexes a fraction of the WDM signal into n sub-band and detects sub-band optical power P_{B1}, . . . P_{Bn}. Any change in the spectrum of the WDM signal is detected as a power decrease or increase by the detectors, and the model re-distributes the power variation over the predicted launch spectrum accordingly. For n>1, power re-distribution affects only the sub-band(s) with the added/dropped/failed channel(s).

### PRIORITY PATENT APPLICATION

Continuation-in-part of U.S. patent application “Line Amplification System for Wavelength Switched optical Networks” (Jones et al.) Ser. No. 09/975,362, filed Oct. 11, 2001 and assigned to Innovance Inc., docket 1004US.

### RELATED PATENT APPLICATIONS

U.S. patent application “Connection Optimization and Control in Agile Networks” Jones et al.) Ser. No. N/A filed Sep. 16, 2002 and assigned to Innovance Inc., Ser. No. ______ docket 1029US, incorporated herein by reference.

### FIELD OF THE INVENTION

The invention resides in the field of optical communication, and is directed in particular to ways of controlling the gain of the optical amplifiers in WDM optical networks.

### BACKGROUND OF THE INVENTION

Modern optical WDM (wavelength division multiplexing) networks transport a plurality of information carrying channels between network nodes that are connected by a line system. The line system includes the optical components and the fiber between two successive switching or OADM (optical add/drop multiplexing) nodes, and is concerned with conditioning the WDM signals to achieve long-haul transmission.

Most popular optical amplifier is currently the fiber amplifier that uses an optical fiber doped with a rare earth element such as erbium, called EDFA (Erbium doped fiber amplifier). State-of-the-art optical fiber systems that operate at 2.5 Gb/s or 10 Gb/s and at a nominal system wavelength of 1550 nm, use EDFAs spaced up to 100 km apart. Although the EDFAs can support very long fiber spans by significantly increasing the optical power of all optical channels passing through them, they exhibit a wavelength-dependent gain profile, noise profile, and saturation characteristics. Hence, each optical channel experiences a different gain along a transmission path. This gain tilt is controlled typically by equalizing the performance (generally the power) of all channels along each fiber span when the system is installed, called span equalization. It is also possible to address this problem by selecting the wavelength of the traffic-carrying channels of the WDM signal so as to have a similar natural tilt; however, this is not always possible, especially for networks with high channel density. Another solution used lately is to provide the optical amplifiers with dynamic gain flattening means.

In recent years, as optical technology evolved, there has been an increased interest in Raman lasers and amplifiers and they are now starting to find applications in optical WDM networks. Distributed Raman amplification, which is achieved by pumping the transmission fiber with light of a certain power, reduces the effective fiber loss; this improves the OSNR (optical signal to noise ratio). It is also known to use hybrid Raman and EDFA optical amplifiers.

Raman amplification is based on the Stimulated Raman Scattering (SRS) effect. SRS distributes the pumped optical power between the channels present on the respective fiber span. This transfer is wavelength dependent, in that the longer wavelength channels get more power than the short ones. This gain is determined by the difference between the gain measured with and without the pump power and is called here the “Raman gain” (or the “on-off gain” or the “SRS gain”). In addition to compensating the attenuation in the fiber, use of SRS allows extension of transmission band to wavelengths outside the gain band of Erbium, gives a very broad gain bandwidth and distributed amplification. As a result of using hybrid Raman-EDFA optical amplifiers and the above corrective techniques, distances of over 3,000 km were obtained lately experimentally, and research for increasing this distance continues.

The shape of the Raman gain can be changed by changing the wavelength(s) of the pump(s). The pump wavelength is typically ˜13 THz below peak signal gain (the Stroke shift), and injects light in a direction opposite to the traffic flow; pumping in the forward direction is also possible. Use of a pump that is detuned from the signals by about one Stokes shift (½ the Stoke shift to 3/2 the shift) is referred to as first-order Stokes pumping. Multiple-order Raman amplifier systems are systems that use two or more pump wavelengths for increasing the reach, flattening the Raman gain, reducing the noise and nonlinearities. As there is a relationship between the wavelengths amplified by the SRS and the pump wavelength, selection of the Raman pump wavelength depends on the transmission band used for traffic. A system may for example use first order Raman pumping at 1430-1475 nm and second order pumping at about 1345 nm, while directing the second order pump light to co-propagate with the WDM signal and the first order pump to counter-propagate with the signal.

The Raman gain in the first order for a fixed pump setting is dependent on the number and power of signal channels.

On the other hand, SRS redistributes the optical power between the channels of the WDM signal by transferring power from the shorter wavelength channels to the longer wavelength channels. Since the data intensity-modulate the optical channels, SRS gives rise to inter-channel cross talk. This signal-to-signal interaction is called here S-SRS gain.

The S-SRS gain depends not only on the number and power of the channels, but also on the location of the channels in the WDM signal (i.e. channel wavelength). The S-SRS gain has two effects on the WDM signal, namely tilt and offset. The tilt refers to the difference in gain between the channels and the offset refers to the difference in the gain for a certain channel incurred by the presence of the co-propagating channels (position, power and number).

The combined effect of spectral fiber loss, SRS gain (on-off gain) and the S-SRS gain is referred to as the “fiber gain”. To summarize, the fiber gain is a function of the power of the pump(s), the wavelength of the pump(s) and the spectrum of the WDS signal that is Raman amplified. Assessing the benefits and impairment induced by the SRS requires knowledge of the spectral dependence of the Raman gain. This dependence is particularly relevant in agile networks, where the number and wavelength of the channels change in time, while the Raman gain must be maintained at a target value.

As indicated above, in traditional point-to-point optical networks, the WDM signal on any line has a fixed channel allocation. Also, traditionally, the performance of the line amplification system is enhanced using off-line span equalization, meaning that each optical amplifier installed along a transmission line is specifically provisioned and set-up in a certain operating point, based on the respective span parameters. Span equalization importantly increases the network costs because it is time consuming and results in a plurality of distinct hardware variants for each span. Furthermore, span equalization is performed based on the power of the worst performing channel; this is clearly not an efficient way of utilizing the network resources.

On the other hand, in an agile network, the number (channel density), wavelength (channels positions in the transmission band) and power of the channels in a WDM signal traveling between two switching nodes changes at arbitrary moments in time. For a comprehensive control, agile networks must use current (on-line) measurements of the operational parameters of the optical components in the way of the WDM signal to perform real-time control of the optical amplifier according to the current conditions. Due to this spectral dependency, independent control of the gain of each channel in a WDM signal is not an easy task.

There is a need to provide modern transmission networks with an optical amplifier that achieves a target gain for each channel in a WDM signal irrespective of the number, wavelength and power of the co-propagating channels. Such an optical amplifier needs to optimize performance of each channel based on current physical performance parameters of the respective channel path, in the context of gain variations due to dynamic configuration and reconfiguration of the network. These optical amplifiers also need to address very fast these gain variations using inexpensive and simple solutions.

### SUMMARY OF THE INVENTION

It is an object of the invention to provide an agile optical network with ways to predict and counteract gain variations in the line system.

It is another object of the invention to separate the network into gain sections, controlled with optical control loops designed to improve transmission line performance and stability in the presence of dynamic network connectivity reconfiguration.

Another object of the invention is to provide an optical amplifier with a high-speed single ended gain measurement for enabling a fast loop response to changes in the spectrum, power distribution and number of channels in a WDM signal traveling along a respective network section.

Still another object of the invention is to provide a Raman amplifier module with a model of the fiber gain based on the single ended gain measurement that is used for predicting the fiber gain for each channel and controlling the performance of each channel individually.

A further object of the invention is to provide with means for controlling the Raman pumps based on the fiber gain predicted with the model.

Accordingly, the invention provides a Raman module for amplifying a WDM signal with a dynamic spectrum traveling on a fiber span, comprising: a detecting unit for measuring a performance parameter of the WDM signal at the Raman module; a spectral gain estimating unit for determining an estimated vector gain Gainₘₑₐₛ based on the performance parameter alone; and a Raman pump unit controlled with a gain Gain_{RA} evaluated based on the estimated gain Gainₘₑₐₛ for generating a pump signal and lunching same over the fiber span.

According to another aspect, the invention provides a Raman module for amplifying a WDM signal with a dynamic spectrum traveling along a fiber span, comprising: a detecting unit for separating a fraction of the WDM signal, separating same into n sub-bands and providing a sub-band performance parameter for each sub-band; a spectral gain estimating unit for determining an estimated vector gain Gainₘₑₐₛ based on the n sub-band performance parameters; and a Raman pump unit controlled with a gain Gain_{RA} evaluated based on the estimated vector gain Gainₘₑₐₛ for generating a pump signal and lunching same over the fiber span.

Still further, the invention is directed to a pump unit for a Raman module comprising a pump block with a first pump assembly operating at a first wavelength and a second pump assembly operating at a second pump wavelength for generating a WDM Raman pump signal and a pump controller for adjusting the power of each Raman pump assembly according to a control signal.

A method for determining the spectrum of a WDM signal with a dynamic spectrum comprises, according to this invention: measuring n sub-band powers of the WDM signal at the output of a Raman module; determining the number of channels in each sub-band; assuming a spectral distribution for the WDM signal, estimating an output power for each channel using a fiber gain model and calculating an estimated sub-band power for each sub-band; comparing the measured sub-band powers with the estimated sub-band powers to obtain an error signal; and adjusting the spectral distribution to minimize the error signal.

According to a still further aspect, the invention provides a method for controlling the gain of an optical WDM signal with a dynamic spectrum, the WDM signal traveling along a fiber link between two switching nodes of an agile network, comprising: breaking the fiber link into gain controlled sections, and providing an optical amplifier at the egress side of each section; providing a spectral gain estimating unit at each optical amplifier for determining the actual spectral gain for each section; controlling a Raman pump at each optical amplifier to adjust the actual spectral gain to a target gain, wherein the target gain is substantially equal for all sections of the fiber link.

Advantageously, breaking the network into gain controlled sections allows improving the loop response to churn, and also improves the network stability.

Another advantage of the invention is that it uses a high speed single ended gain measurement that enables a fast loop response to changes in the spectrum, power distribution and number of channels of a WDM signal traveling along a respective network section. Thus, local detectors placed at the output of the Raman stage provide a real-time measurements of the output power for sub-band of channels, and the measurements are used by a model of the fiber gain which predicts the gain for the current number and placement of the channels in the WDM signal. A solution with a single detector may also be used.

Still another advantage of the invention is that the model of the Raman stage realistically estimates the performance of the entire fiber section based on current performance parameter(s) measurements and on fiber characteristics. The model is continuously updated with the latest measurements, to enable calculation of a target gain for the respective Raman stage, in the context of the gain target for the entire optical span and path. The model is flexible and new features may be added without any changes to the amplifier structure. For example, full or partial knowledge of the launch spectrum can be used to improve the accuracy.

The model may use a generic algorithm to find a best match of the measurements with a predicted launch spectrum. As such, the model error for spontaneous channel additions can be minimized. Partial knowledge of the launch spectrum assists in the convergence and accuracy of this method.

The gain predicted with the model is then used to control the Raman pumps. The pump control advantageously accounts for the dropped and/or failed channels. Thus, this change in the spectrum is detected as a power decrease at the detector(s), and the model re-distributes the power decrease over the predicted launch spectrum accordingly. For multiple detectors monitoring, this power re-distribution affects only the sub-band(s) with the dropped/failed channel(s). Similarly, channel additions are detected as power increases at the detector(s), and the change is treated as if it is a power increase on the known active channels monitored by the detector. For multiple detectors monitoring, this power re-distribution affects only the sub-band(s) with the added channel(s).

### BRIEF DESCRIPTION OF THE DRAWINGS

The foregoing and other objects, features and advantages of the invention will be apparent from the following more particular description of the preferred embodiments, as illustrated in the appended drawings, where:

FIG. 1A is a block diagram of a typical Raman amplifier;

FIG. 1B is a power versus fiber length graph for a Raman pumped fiber, compared with a fiber that is not Raman-pumped;

FIG. 2A is a graph showing the fiber gain (Raman gain plus S-SRS gain minus fiber loss) obtained with a fixed Raman pump power for WDM signals having a different numbers of channels;

FIG. 2B is a graph of the Raman gain only for the example of FIG. 2A;

FIG. 2C is a graph of the S-SRS gain tilt and the fiber loss for the example of FIG. 2A;

FIG. 3 shows a block diagram of the Raman amplifier according to an embodiment of the invention;

FIG. 4A shows a block diagram of the spectral gain estimating unit of the Raman amplifier according to an embodiment of the invention, where the fiber gain is determined based on an iterative calculation method;

FIG. 4B illustrates the block diagram of the Raman amplifier according to another embodiment of the invention, where the fiber gain is determined using a direct calculation method;

FIGS. 5A(a) and 5A(b) show a first example of fiber gain estimation obtained with one detector, where FIG. 5A(a) shows channel power (variable) versus the estimated channel location (fixed), and FIG. 5A(b) shows the fiber gain estimation;

FIGS. 5B(a) and 5B(b) show a second example of fiber gain estimation obtained with two detectors, where FIG. 5B(a) shows channel power (variable) versus channel location (fixed), and FIG. 5B(b) shows the fiber gain estimation;

FIGS. 5C(a) and 5C(b) show a third example of fiber gain estimation obtained with four detectors, where FIG. 5C(a) shows channel power (variable) versus channel location (fixed), and FIG. 5C(b) shows the fiber gain estimation;

FIGS. 6(a) and 6(b) show a fourth example of fiber gain estimation obtained with four detectors, where FIG. 6A(a) shows channel power (fixed) versus the estimated channel location (variable), and FIG. 6A(b) shows the fiber gain estimation;

FIG. 7A illustrates a further embodiment of a Raman pump unit with a third tilt compensating pump for gain tilt adjustment; and

FIG. 7B is a graph showing the gain tilt for different backward pump power levels of the third pump shown in the embodiment of FIG. 7A.

### DETAILED DESCRIPTION OF THE PREFERRED EMBODIMENTS

The present invention is directed to the gain control of a Raman amplification module.

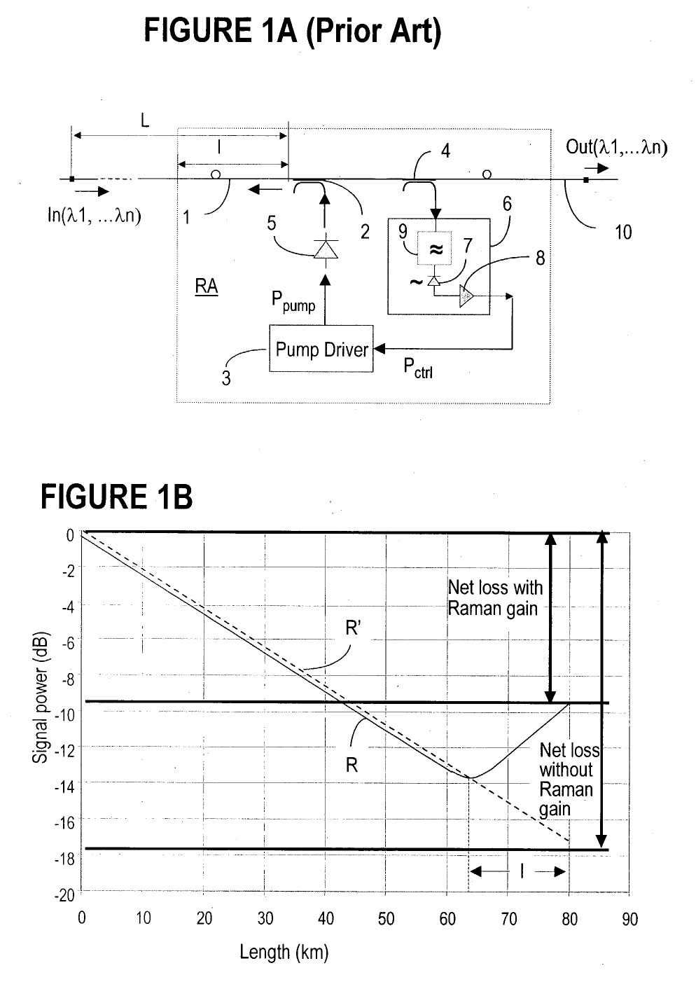

FIG. 1A shows a typical Raman amplifier equipped with one or more pumps 5 for injecting light at high power Pₚᵤₘₚ in the optical transmission fiber 10. A coupler 2 directs the pump light in the same direction with the traffic (i.e. the WDM signal In(λ₁. λₙ), or in the counter-propagating direction. In the example of FIG. 1A, the pump signal Pₚᵤₘₚ is reverse-pumped with respect to the WDM signal.

FIG. 1B shows a power (or gain) versus length graph for a Raman-pumped fiber, graph R, compared with the same fiber that is not Raman-pumped, graph R′. It is to be noted that the Raman amplification effect decreases with the distance from the point of injection, so that it compensates for the fiber loss for a length ‘l’ out of the entire span length ‘L’ shown in FIG. 1A.

Modern Raman amplifiers are provided with a monitoring unit 6 for measuring the signal power, pump reflections, or/and pump power. The measurement of Pₒᵤₜ is effected by inserting a tap 4 on fiber 10 downstream from the insertion of the pump signals. Tap 4 separates a small fraction of the WDM signal and provides it to unit 6, which is generally equipped with a monitor photodetector (MPD) 7 and an amplifier 8. A filter 9 may also be provided for example when the power of the pump wavelength in the forward direction is to be measured. A pump driver 3 adjusts the optimal pump power based on these on-line measurements. For example, the U.S. Pat. No. 6,388,801 B1 (Sugaya et al.), issued on May 14, 2002 describes a Raman amplifier with a monitor for measuring the power input to the EDFA stage. This measurement is used for determining the noise figure of the EDFA stage and controlling the Raman pump so as to optimize the noise figure of the entire amplifier.

To summarize, Raman amplifier shown in FIG. 1A operates satisfactory in static WDM systems, where the number and position of channels in the WDM signal do not change, and also, the power of the channels in the WDM signal does not change significantly in time. In this case, the operation point of the Raman pumps can be set for life for each span or section of fiber, and the respective pump driver adjusts the power of the pumps around this value. Dynamic response to channel changes is not supported.

Some other current line systems measure the spectral power at both ends of the fiber section and determine the gain as the power difference between these measurements. However, this method is too slow to respond to fast spectrum changes as in agile networks.

In agile networks, channels are added and dropped at switching/OADM nodes at arbitrary moments. Channel failure also occurs at arbitrary moments. As a result, the power, number and position of the channels in the WDM signal (i.e. the spectrum) traveling along a certain fiber link, and through the optical amplifiers connected on that fiber, also change arbitrarily in time. Dynamic source channel changes (network churn) alter the gain experienced by existing/remaining channels. We define such a WDM signal as a “WDM signal with a dynamic spectrum”.

The invention described in the parent patent application identified above as Ser. No. ______ Docket 100US proposes to separate each line of an agile network (i.e. the fiber and equipment between two switching/OADM nodes) into gain-controlled sections. Each section is controlled individually by a span loop that receives a gain target, and the loop control coordinates the actions of the various optical devices in the amplifier group, to achieve a control objective for the amplifier as a whole. The entire line is controlled by coordinating the actions of all sections to achieve a control objective for the line as a whole.

The Gain of a Raman module is given by the ratio between the power at the output of the upstream amplifier, which is the input power Pᵢₙ of the section, and the power Pₒᵤₜ at the output of the respective module.

It is known to transmit the input power measurement Pᵢₙ from the section input to the Raman amplifier site over a service channel (telemetry); this channel is separated at each amplifier site. However this solution is not satisfactory for a high-speed response. High speed control is cheaper and easier to perform when measurement and compensation are performed at the same end of the fiber. High speed control is also very important in agile networks.

The present invention solves this problem by using a single ended measurement, namely a power measurement at the output of the Raman module. To compensate for the gain variations/channel, the Raman module is provided with the knowledge of how the gain changes with the number, position and power of the channels in the WDM signal in order to estimate the gain based only on one power measurement.

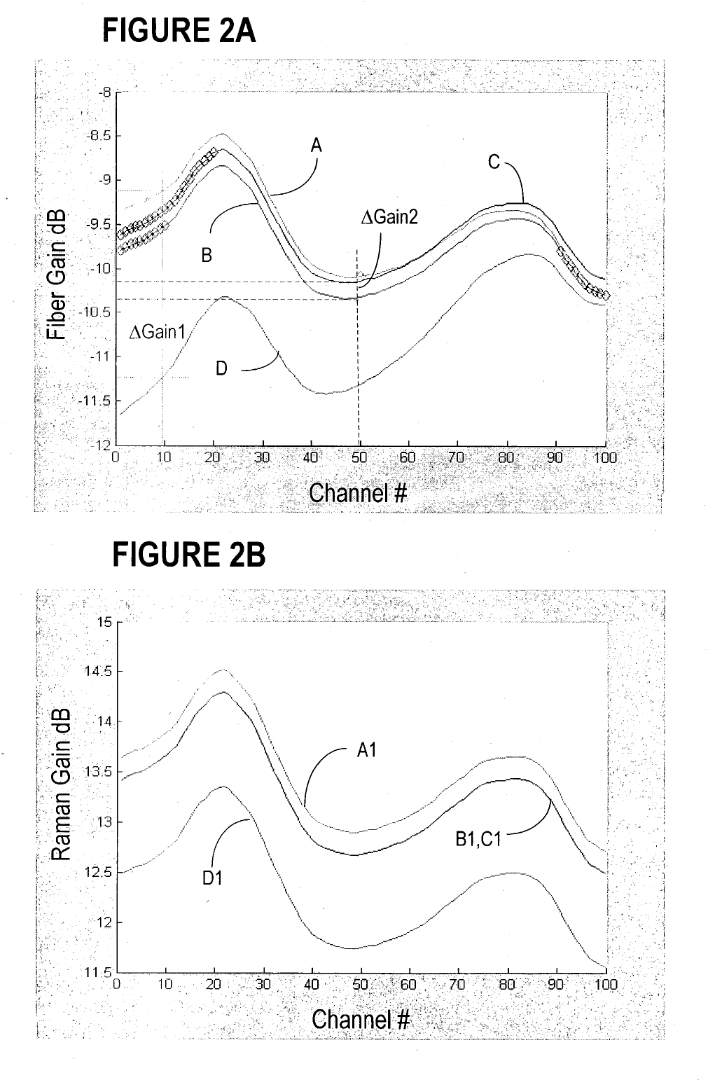

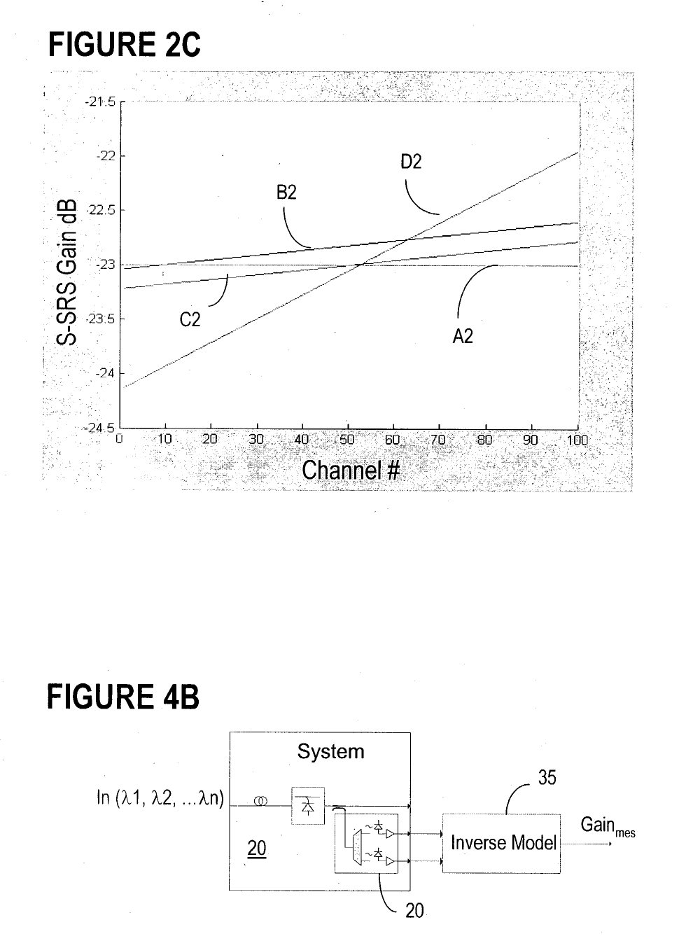

FIG. 2A is a graph showing the fiber gain obtained with a fixed Raman pump power for WDM signals having a different numbers of channels. Thus, graph A shows the gain variation for a one-channel signal, graphs B and C show the gain variation for a 20-channel WDM signal (the position of channels in graphs B and C differs), and graph D shows the gain variation for a 100-channel WDM signal. FIG. 2A also shows an example of the fiber gain for channel #10. Thus, if the WDM signal includes channel #10 only, the fiber gain is that shown on graph A at about −9.9 dB. If the WDM signal comprises 100 channels as shown by graph D, the fiber gain for channel #10 is about −11.6 dB, for the same pump power, which results in a gain difference ΔGain1 of approximately 2.3 dB.

Similarly, there is a gain difference for e.g. channel #50 when the position of the co-propagating channels differ, as shown by ΔGain2 between the graphs B and C which both represent a WDM signal with 20 multiplexed channels. It can be seen on FIG. 2A that the maximum gain variation ΔGain is between graph A (one active channel) and graph D (100 active channels), and it is equal to 2.3 dB:

| | |
|---|---|
| A-B | 0.46 dB |
| A-C | 0.23 dB |
| A-D | 2.30 dB |
| B-C | 0.18 dB |
| B-D | 1.85 dB |
| C-D | 2.03 dB |

It can also be seen that the gain variation decreases for the higher wavelength channels, which are here illustrated by a higher channel number.

FIG. 2B shows the Raman gain only, illustrating the spectral dependence on number of channels. Graph A1 shows the Raman gain for a one-channel signal, graph B1, C1 for a 20-channel WDM signal, and graph D1 for a 100-channel WDM signal. It is apparent that the Raman gain depends on the number and power of the signal channels.

FIG. 2C shows the S-SRS gain variation and the fiber loss for the example of FIG. 2A. Namely, graph A2 shows the S-SRS for a one-channel signal, graphs B2 and C2 for a 20-channel WDM signal, and graph D2 for a 100-channel WDM signal. It is apparent form FIG. 2C that the S-SRS shown by graph A2 is substantially constant (horizontal), the S-SRS graphs B2 and C2 for the same number of channels (20) present a similar tilt, and that graph D2 has a substantial tilt. The S-SRS gain depends on the number, power and location of the channels in the WDM signal.

To summarize the information given by graphs of FIGS. 2A-2C:

the fiber 10 attenuates the input signals (i.e. the WDM signal at the input of the transmission span).

the high power (counter)-propagating Raman pump wavelengths add stimulated Raman scattering (SRS) gain. The Raman gain depends on the Raman pump(s) power, and on the number and power of the signal channels.

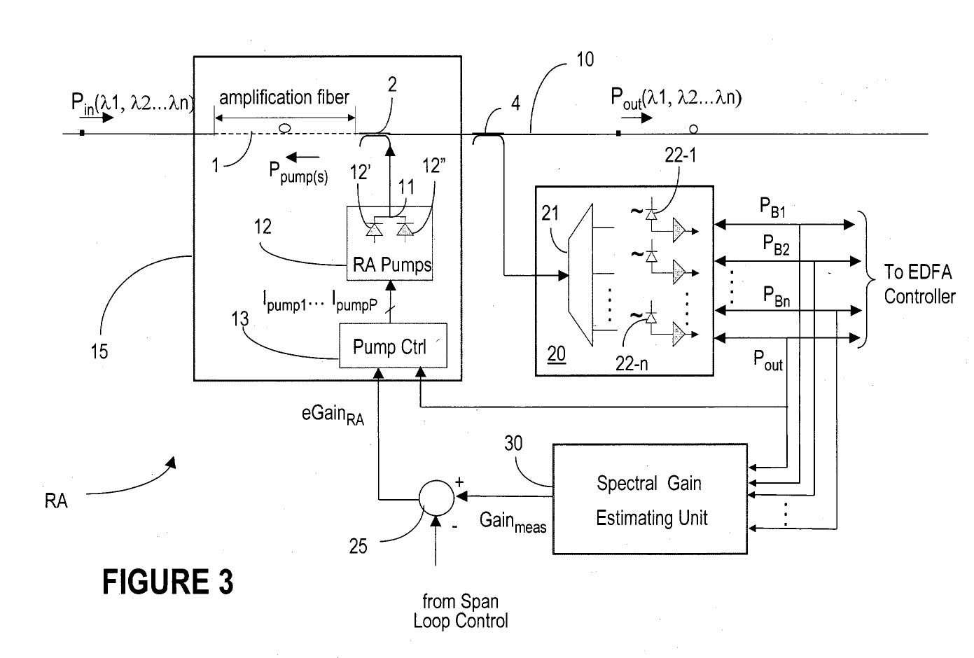

signal to signal (S-SRS) gain depends on the number, power and location of the individual channels in the WDM signal. S-SRS interaction adds gain tilt and offset. The offset increases as the active channels move from higher wavelengths to lower wavelengths. Offset also increases as the channel power increases. This information is used by a spectral gain estimating unit, shown in FIG. 3.

In order to provide a pump control signal that takes into account all these factors, the Raman amplifier RA according to the invention is equipped with an on-line output power detecting unit 20 and a spectral gain estimating unit 30 as shown in FIG. 3. The detecting unit measures the power of the WDM signal at the output of the Raman module, while the gain estimating unit provides an estimated value of the gain Gainₘₑₐₛ for each channel (Gainₘₑₐₛ is a vector) based on this measurement. The estimated gain Gainₘₑₐₛ is compared at 25 with the gain target received from the span control loop, to determine the operating point for the Raman pumps in the context of the entire optical amplifier. The pump unit 15 receives the gain error eGain_{RA}, which is a vector with the corrections for each channel, and determines the current for each pump of the Raman module.

The optical span loop, whose operation is disclosed in the above-identified patent applications Ser. No. ______ Docket 1004US and Ser. No. ______ Docket 1029US, is a vector loop that encompasses the fiber between two successive optical amplifiers and the optical devices set of a respective downstream optical amplifier. To summarize, the device set may include a Raman amplifier, and EDFA amplifier, means for controlling the dispersion (a dispersion compensating module DCM) and means for flattening the gain (a dynamic gain equalizer DGE or a variable optical attenuator VOA). The loop control distributes the gain calculated for the entire transmission span to the optical devices of the optical amplifier. The gain control signal Gain_{RA} (for the Raman amplifier) accounts for the specifications, measurements and state of the optical devices of the device set, the fiber specification, wavelength power targets, and commissioning measurements.

The Raman pump unit 15 encompasses a pumps block 12, which uses a certain number of pumps p (pε [1,P]). The pump wavelengths are combined by a p:1 combiner 11, which is generally followed by a multiplexer and depolarizer block (not shown). Preferably, the Raman amplifier of FIG. 3 uses four pumps, two operating at a pump wavelengths of 1461 nm and the other two at 1492 nm, to optimize the spectrum across the operating band of the EDFA band (1550 nm-1610 nm). The pump signal resulted by combining the signals generated by all pumps is inserted on fiber 10 in the reverse direction with respect to the WDM traffic using a directional WDM coupler 2. Isolators (not shown) are provided for blocking reflections from the couplers, as well known.

Use of first-order Stokes pumping (one pump wavelength) has several limitations. Namely, the power of a strong Raman pump in amplifying a weak signal always decreases exponentially with of distance as the light propagates into the transmission fiber, as seen in FIG. 1B. This means that regardless of how powerful the pump, most of the amplification occurs relatively near the point where the pump is injected into the fiber (typically within 20 km). This significantly limits the improvement in the signal-to-noise ratio that the Raman pump can induce. As the pump power is increased, Rayleigh scattering of the signal limits the improvement in the signal-to-noise ratio.

Pump controller 13 enables control of the Raman pumps 12 and it is designed to automatically adjust the pump power to compensate for Raman saturation. It determines the pumps power individually based on the Gain_{RA} received from the loop control, and adjusts the ratio between the pumps power, as seen later.

Detecting unit 20 provides information about the power Pₒᵤₜ of the WDM signal downstream from the pumps and, in certain embodiments also provides information about the power distribution in the WDM signal on transmission sub-bands. The measurement is effected by inserting a tap 4 on fiber 10 downstream from the insertion of the pump signals. Detecting unit 20 uses n (nε[1,N]) optical detectors 22-1 to 22-n. Preferably, the detectors are monitor photodiodes (MPD), but other devices that convert light into electrical signals may equally be used.

For n>1, each photodetector measures the power P_{SB1} to P_{SBn} in a different sub-band of wavelengths, the set of sub-bands encompassing all the available channels (transmission band). In this case, detecting unit 20 is provided with a band demultiplexer 21, which directs the channels in each sub-band to a respective MPD 22-1 to 22-n. Each detector provides the respective regenerated (electrical) signal proportional with the power of the channels in the respective sub-band. Using more than one MPD 22 allows estimation of the position of the channels in the current WDM signal with more accuracy than in the case of a single MPD, since a single detector can detect S-SRS gain tilt, but not the channel dependent offset. In addition, the EDFA controller (not shown) uses these signals to automatically adjust the EDFA gain to compensate for the S-SRS gain and to adjust the optical attenuator for compensating for the excess EDFA gain and S-SRS gain. The adjustments can be made based solely on the sub-band power detector readings.

The spectral gain estimating unit 30 includes a representation of the Raman gain behavior that allows for high-speed predicting and counteracting gain variations using only the measurements effected by the detecting unit 20. Use of unit 30 allows enhancements and further intelligence to be added to the Raman pump unit 15 without directly impacting the architecture of the amplifier.

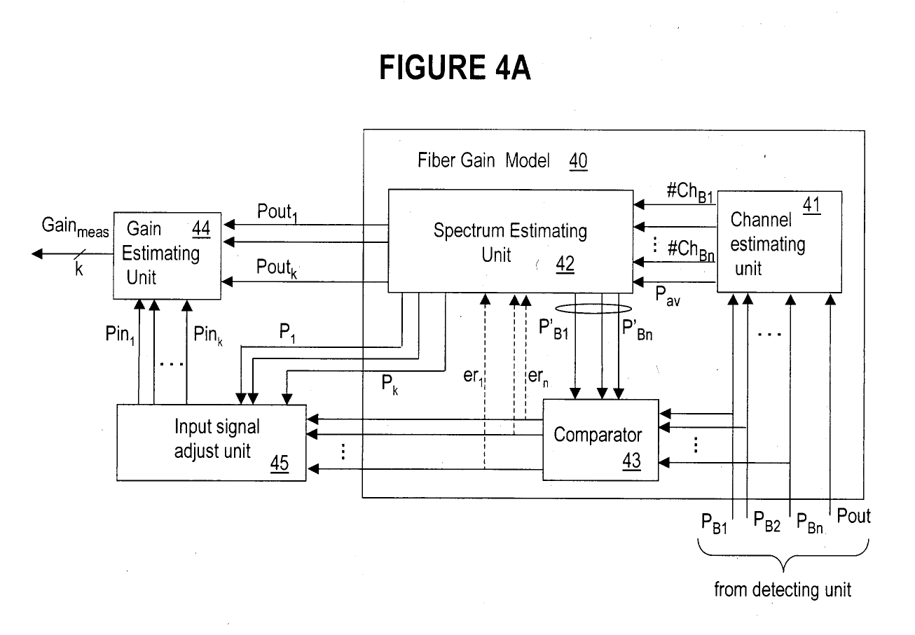

FIG. 4A illustrates a block diagram of the spectral gain estimating unit 30 according to an embodiment of the invention, where the fiber gain is determined based on an iterative calculation method. To determine the gain of the Raman amplifier with access to only output power measurements (single ended measurement), the gain estimating unit 30 uses a model 40 of the fiber gain. The model is based on measurements performed at the output of the Raman stage with and without traffic on fiber 10, and with the channels positioned in various locations of the spectrum. The fiber gain Gainₘₑₐₛ is calculated using the per channel estimated output powers Pout₁-Poutₖ, where k is the number of channels in the WDM signal, and the input power estimations Pin₁-Pinₖ, provided by an input signal adjust unit 45. The model sub-band powers P′_{B1} to P′_{Bn} are compared with the system sub-band powers P_{B1} to P_{Bn}, and the model modifies the estimated spectrum (power or channel location) until, after a number of iterations, the estimated and measured values converge. At that time, a gain calculating unit 44 determines the gain (in dB) Gainₘₑₐₛ as the difference between the estimated input and output channel powers, and this value is fed to the control loop for providing the new Gain_{RA}.

The iterative method performed by the embodiment of FIG. 4A operates in a “fixed channel location-variable power” mode, or in a “variable channel location-fixed power” mode. This drawing illustrates a general case where the detecting unit 20 is equipped with n sub-band detectors providing sub-band power measurements P_{B1,} P_{Bn}; and Pout; the amplifier operates in a similar way for the case of a single MPI.

The fiber gain model comprises a channel number estimating unit 41 which receives the power measurements Pₒᵤₜ, P_{B1}, P_{B2} . . . P_{Bn} and deduces from these measured values an average power/channel Pₐᵥ. Unit 41 then provides an estimation of the number of channels per band Ch_{B1,} Ch_{B2} . . . Ch_{Bn}, by dividing the respective band detector measurement to the average output power Pₐᵥ (linear dependence assumed). For the case of a single detector, this number is denoted with Ch_{B}.

In the “fixed channel location-variable power” mode of operation, a spectrum estimating unit 42 “places” the estimated channels λ1, . . . λm in the center of the respective sub-band B1, . . . Bn, or distributes the channels across the respective sub-band, and allocates an estimated input power P₁ to Pₖ to each channel 1 to k of the WDM signal at the input pf the amplifier. Based on the estimated input powers and on the fiber gain model, unit 42 determines the output powers Pout₁ to Poutₖ for each channel, and the estimated sub-band powers P′_{B1}, ′P_{B2} . . . P′_{Bn}. Comparator 43 determines the difference between the measured values (P_{B1}, P_{B2} . . . P_{Bn}) and estimated values (P′_{B1}, ′P_{B2} . . . P′_{Bn}) as the per-band error signals er₁ to erₖ, which are used to correct estimated per-channel input powers P₁ to Pₖ. This correction is effected until the measured and estimated sub-band powers converge. Adjustment of the input power is performed by the input power adjusting unit 45, which receives the error signal for each band, distributes it among the channels in each respective band to adjusts the input power of each channel. For each new set of input powers, the model calculates a new set of per-channel output powers and determines the respective estimated sub-band powers. The comparisons with the measured sub-band powers is repeated until the two converge.

Gain calculating unit 44 then determines the vector Gainₘₑₐₛ where each component of the vector is given by the difference between the estimated input and output powers for the respective channel, when the error vector is at an acceptable value.

For the “variable channel location-fixed power” mode of operation, the spectrum estimating unit 42 allocates to each channel a certain power and places the channel in the respective sub-band based on this pre-set power. The comparator 43 determines the error vector, which is then used by the spectrum estimating unit 42, shown in dotted lines, to rearrange the position of the channels in the respective sub-bands. To this end, unit 42 uses a generic algorithm to change the wavelengths λ1, . . . λk, so as to minimize the error for each band. A new comparison is performed and the steps are repeated until the estimated and the measured sub-band powers converge.

FIG. 4B illustrates the block diagram of the Raman amplifier according to another embodiment of the invention, where the fiber gain is determined using a direct calculation method. In this variant, the spectral gain estimating unit 30 is an inverse model 35 of the Raman gain. The inverse model 35 is structured as a look-up table or a set of equations that can directly estimate the spectral gain profile. In some cases, this direct calculation is faster and equally as accurate as that obtained with the iterative method.

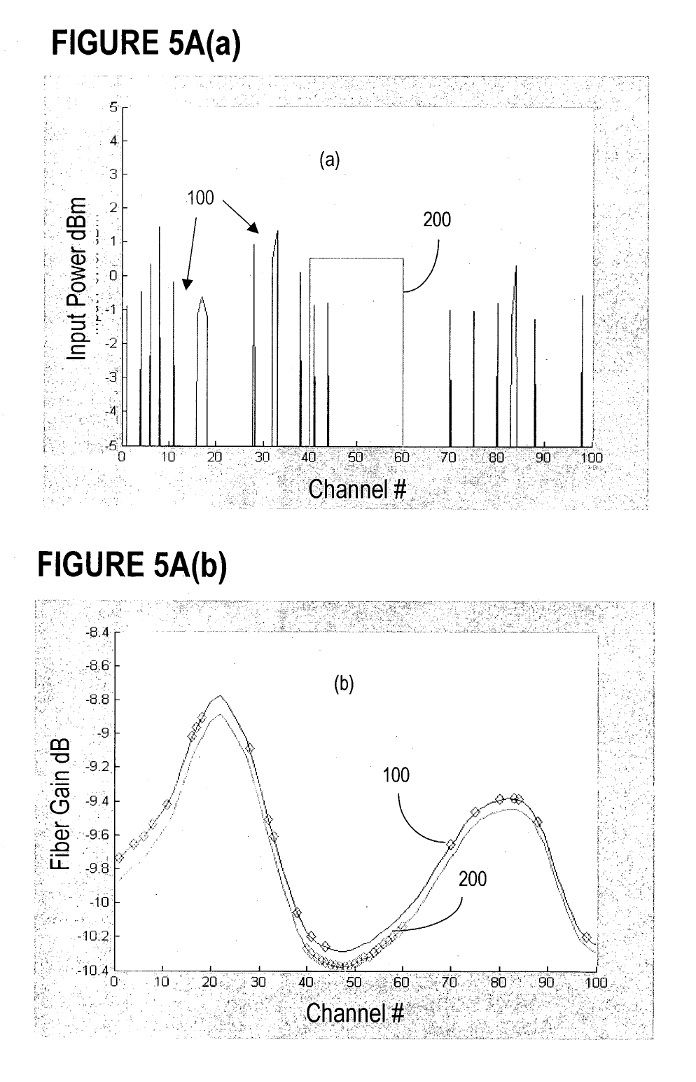

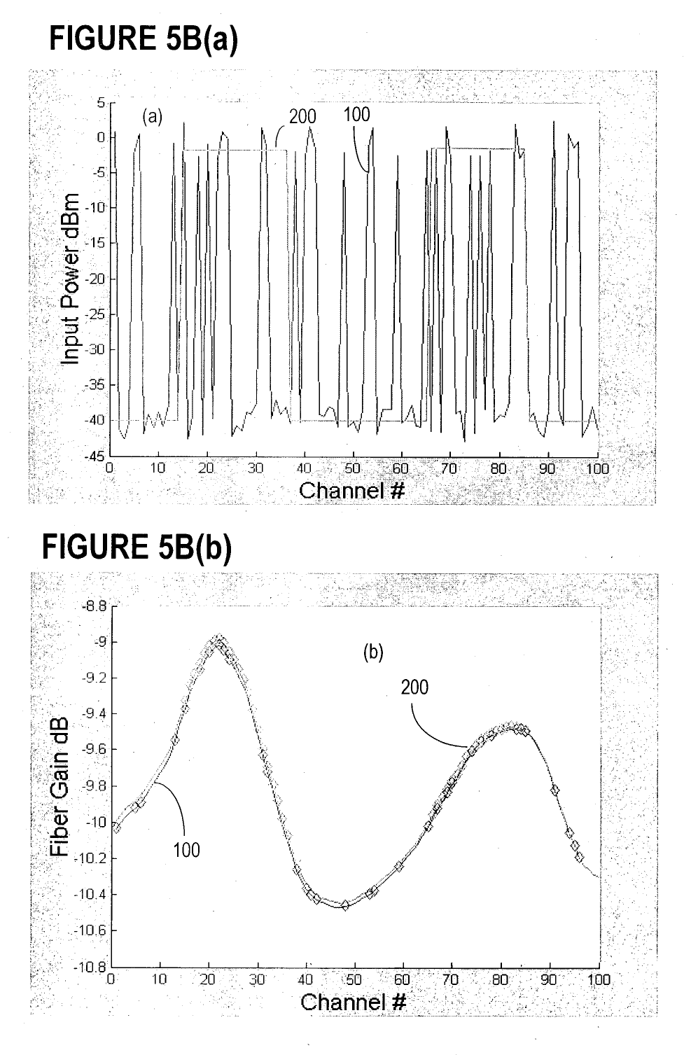

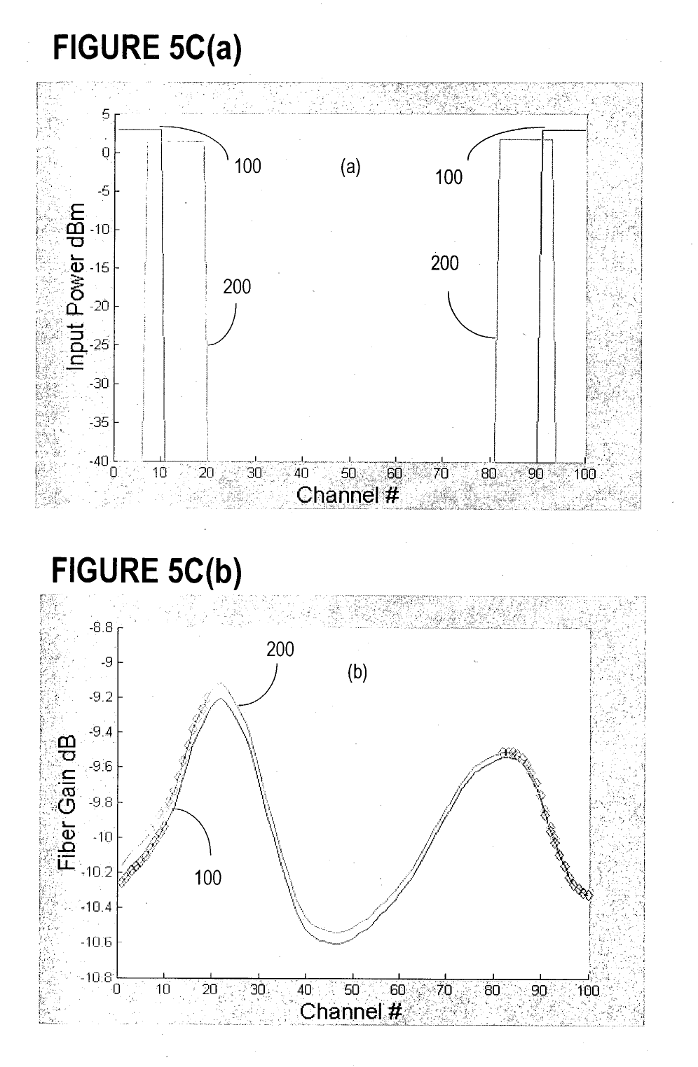

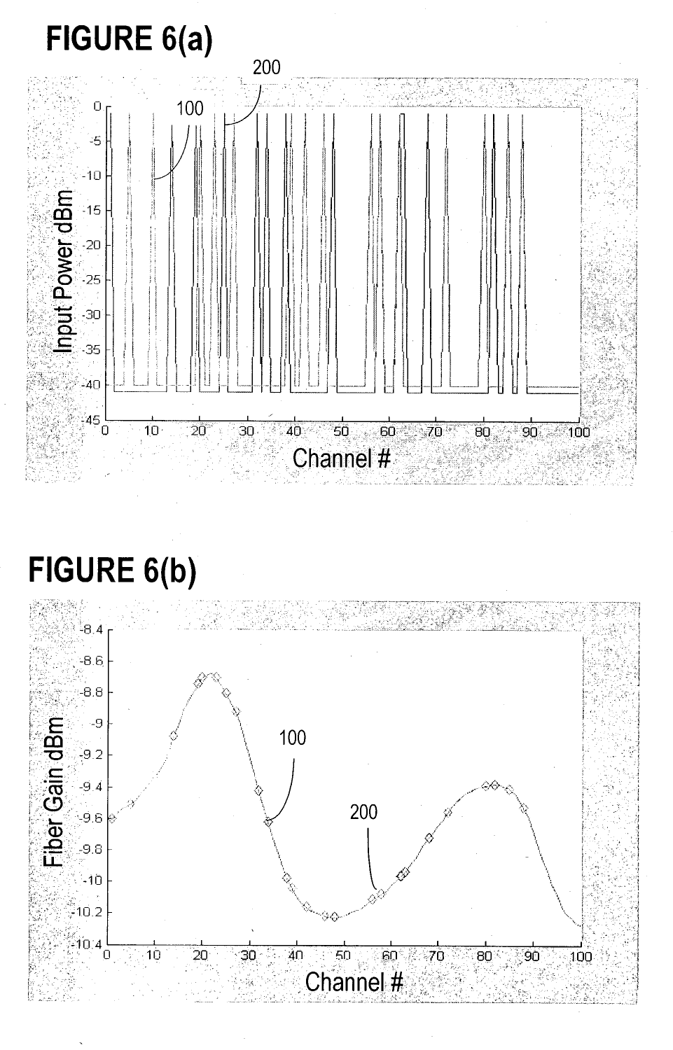

FIGS. 5 and 6 provide examples of fiber gain measurements, shown by 100, versus fiber gain estimates obtained with the arrangement of FIGS. 4A and 4B, shown by 200. The results shown in FIG. 5 are obtained by estimating the channel location and determining the power (“fixed estimated channel location, variable power” mode). The results shown in FIG. 6 are obtained by assuming a certain power for the channels and searching for the channel location (“fixed power, channel location search” mode).

Fixed Estimated Channel Location, Variable Power Mode

As discussed in connection with FIG. 4A, the number of estimated channels in each band is calculated by dividing the band detector power by the average output channel power. The estimated channels are placed in the center of each band, or distributed across the band and their power is adjusted to match the estimated band power with the measured (detector) band power. As indicated above, the actual measurements are denoted with 100 and shown in black, while the estimated values are denoted with 200 and shown in gray.

The first example uses one detector 22, 20 input channels with random channel location, and the input power between −1.5 to 1.5 dBm. FIG. 5A(a) shows input power versus channel position for this example. The model gives 21 estimated channels placed here in the middle of the band (channels #40 to #60). FIG. 5A(b) shows the fiber gain estimation and the fiber gain measurement. The maximum gain difference between the estimate and the measurement is 0.13 dB (the error).

The second example uses two detectors 22-1 and 22-2. FIG. 5B(a) shows input power versus channel position: there are 34 randomly positioned channels with the input power between −3 and +3 dBm. The model gives 42 estimated channels, which are placed as channels #15 to #35 and #65 to #85. Graph 100 of FIG. 5B(b) shows the fiber gain measurements, and graph 200 shows the gain estimated with the model of FIGS. 4A and 4B. The maximum gain difference between the estimate and the measurement (the error) in this example is 0.05 dB.

The third example uses four detectors 22-1 to 22-4. Again, FIG. 5C(a) shows input power versus channel position: there are 20 channels placed in this example as channels #1 to #11 and #90 to #100, having an input power of 3 dBm. The model gives 25 estimated channels, placed as channels #8 to #20 and #81 to #92. FIG. 5C(b) illustrates the fiber gain measurements on graph 100 and the gain estimated with the model, graph 200. The maximum gain difference between the estimate and the measurement (the error) is 0.11 dB.

Simulation results for these examples and others are summarized in the Table 1 below. Each entry shows the system conditions, model settings and the number of detectors. The maximum gain difference between the system and the model is shown in last column.

TABLE 1

| | Channel number | | Channel location | | Power (dBm) | | Maxim Gain |
|---|---|---|---|---|---|---|---|
| | System | Model | System | Model | System | Model | error (dB) |
| one | 20, | 21 | random | 40-60 | −1.5 − 1.5 | 0.5 | 0.13 |
| detector | 10 | 7 | random | 47-53 | −1 | 0.5 | 0.03 |
| | 10 | 7 | 1-10 | 47-53 | −3 to +3 | 0.5 | 0.17 |
| | 35 | 35 | 1-35 | 1, 3, . . . 97, 99 | −1 | −2 | 0.30 |
| two | 10 | 12 | 1-10 | 20-32 | 3 | 2 | 0.1 |
| detectors | 35 | 43 | 1-35 | 4-46 | −1 | −1.5 | 0.07 |
| | 34 | 42 | random | 16-37, 66-85 | −3 to +3 | 0.5 | 0.05 |
| four | 20 | 25 | 1-10, 90-100 | 8-20, 80-92 | 3 | 1 | 0.11 |
| detectors | | | | | | | |

Results show that a distributed placement of channels is better for the case of a single detector. It also shows that sensitivity to error in the estimation of the number of channels is low.

Fixed Power Channel Location Search Mode

This mode of operation assumes that the channels meet a certain power (indirectly a certain gain) when they were launched. The number of estimated channels in each band is calculated by dividing the band detector power by average output channel power. The estimated channels are placed in the center of each band. The channel positions are then rearranged using a generic algorithm to match the estimated band power with the band detector power.

Simulation results for four tests are summarized in the Table 2 below. As for Table 1, each entry in Table 2 shows the system conditions and the model settings. The maximum gain difference between the system and the model is shown in the last column. The number of detectors is four in all examples.

TABLE 2

| Channel number | | Channel location | | Power (dBm) | | Maxim Gain |
|---|---|---|---|---|---|---|
| System | Model | System | Model | System | Model | error (dB) |
| 20 | 20 | 1-10, 90-100 | ⁽1-9, 11, 90- | −1. | −1 | 0.0003 |
| | | | 100 | | | |
| 15 | 15 | random | random | −1 | −1 | 0.0007 |
| 20 | 20 | 1-10, 90-100 | 4, 6, 8, 12, 17- | −1 | −2 | 0.091 |
| | | | 18, 20-22, 25, | | | |
| | | | 77-86 | | | |
| 20 | 25 | 1-10, 90-100 | 10-12, 88-100 | −1 | −2 | 0.085 |

The examples in the third and the fourth rows show sensitivity to input channel power and number inaccuracy.

FIGS. 6(a) and 6(b) show a fourth example (as per line 2 of Table 2), where graph 100 on FIG. 6(a) illustrates 15 randomly located channels having the channel power fixed at −1 dBm. For this example, the model assumes an input power of −1 dBm, which gives an estimated number of 15 channels. As the detector 20 uses four MPDs 22-1 to 22-4, the transmission spectrum is divided into four sub-bands, each including approximately 25 channels. Thus, the first sub-band detected by sub-band detector 22-1, encompasses channels #1 to #25, and the active channels in this sub-band are #1, #12, #19 and #25. The estimated number of channels Ch_{B1} is obtained by dividing the power at the output of detector 22-1 to the average output channel power, which gives four estimated channels in this example Ch_{B1}=4. These four channels are placed as shown at 200 in FIG. 6(a), as channels #5, #10, #20 and #22. Similarly, the active channels in the second sub-band encompassing channels #26 to channel #50 are in this example channels #31, #38 and #42. The estimated number of channels calculated by unit 30 is Ch_{B1}=4, and the channels are placed as channels #27, #39, #42 and #45. It is apparent that only a partial fit is obtained in FIG. 6A(a).

FIG. 6(b) shows at 100 the fiber gain versus channel position for the measurement and shows at 200 the fiber gain versus the estimated channel position. The maximum gain error is very low, at 0.0007 dB.

To further optimize OSNR performance of the WDM signal over the full channel count, the Raman gain may be actively tilted by changing the ratio between the power of pumps 12, to equalize and minimize the noise performance across the entire transmission band, as disclosed in the priority patent application Ser. No. ______ Docket 1004US.

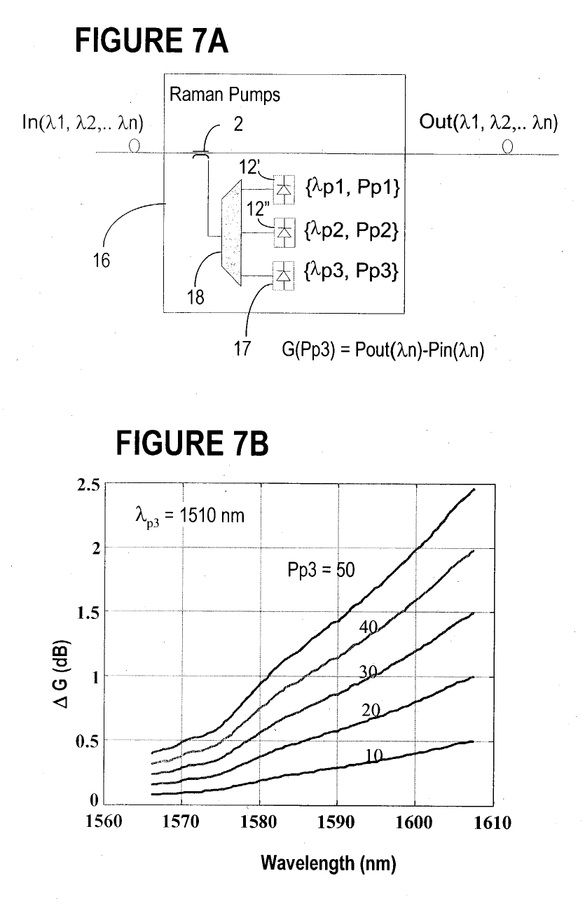

FIG. 7A illustrates an embodiment of a Raman pump unit 16 with a third pump 17 used to adjust the gain tilt for compensating the S-SRS tilt. FIG. 7A also shows the combiner 18 that multiplexes the pump wavelengths λp1, λp2 and λp3 before launching them over the fiber 10. The basic idea is to make use of the linear part of the Raman gain spectral shape. By injecting a third pump wavelength in the region of 1500 to 1520 nm into the transmission fiber, a Raman gain graph with an almost linearly tilted spectral shape can be generated. The gain tilt for the Raman amplifier can be simply adjusted by varying the power level of pump 17. Although either forward or backward pump configuration can be used, the backward pump scheme is preferred due to the effect of PDG and pump-to-signal noise in the forward pumping.

FIG. 7B is a graph showing the gain tilt for different backward pump power levels for pump 17 shown in the configuration of FIG. 7A. In this particular example, the wavelength of pump 17 is set at λ3=1510 nm. It is also assumed that the transmission fiber length is 100 km and the two primary pumps 12′ and 12″ operate at λ1=1461 nm, λ2=1492 nm and Pp1=Pp2=160 mW. It can be seen that a 2 dB gain tilt change can be achieved by adjusting pump power within 50 mW range. An advantage of this gain tilt compensation scheme is that the gain tilt adjustment can be done at higher speed, in order of MHz (limited by the speed of pump power adjustment).

However, due to the direction of the gain tilt generated by pump 17, it is necessary to pre-emphasize (with blue tilt) the channel power launched into the transmission fiber 10 in order to archive the desirable gain tilt adjustment. The system performance implication of the pre-emphasis will need further investigation. It could be desirable, as it will tend to enhance the performance of short wavelength channels.

We Claim:

1. A Raman module for amplifying a WDM signal with a dynamic spectrum traveling on a fiber span, comprising:
a detecting unit for measuring a performance parameter of said WDM signal at the Raman module;
a spectral gain estimating unit for determining an estimated vector gain Gainₘₑₐₛ based on said performance parameter alone; and
a Raman pump unit controlled with a gain Gain_{RA} evaluated based on said estimated gain Gainₘₑₐₛ for generating a pump signal and lunching same over said fiber span.

2. A Raman module as claimed in claim 1, wherein said spectral gain estimating unit comprises:
a fiber gain model for receiving said performance parameter, assuming a predicted input power for each channel in said WDM signal and providing a corresponding estimated output power for each channel in said WDM signal;
an input signal adjust unit for adjusting said predicted input power based on an error signal provided by said fiber gain model; and
a gain calculating unit for obtaining said gain Gainₘₑₐₛ having a component for each channel in said WDM signal based on said predicted input powers and said estimated output powers.

3. A Raman module as claimed in claim 1, wherein said gain estimating unit is an inverse fiber gain model structured as one of a look-up table and a set of equations that estimate the spectral gain profile for the respective measured output parameter and characteristics of said fiber span.

4. A Raman module for amplifying a WDM signal with a dynamic spectrum traveling along a fiber span, comprising:
a detecting unit for separating a fraction of said WDM signal, separating same into n sub-bands and providing a sub-band performance parameter for each said sub-band;
a spectral gain estimating unit for determining an estimated vector gain Gainₘₑₐₛ based on said n sub-band performance parameters; and
a Raman pump unit controlled with a gain Gain_{RA} evaluated based on said estimated vector gain Gainₘₑₐₛ for generating a pump signal and lunching same over said fiber span.

5. A Raman module as claimed in claim 4, wherein said spectral gain estimating unit comprises:
a fiber gain model for receiving said n sub-band performance parameters, assuming a predicted input power P₁ to Pₖ for each channel in said WDM signal and providing a corresponding estimated output power Pout₁ to Poutₖ for each channel in said WDM signal; and
an input signal adjust unit for adjusting said predicted input power based on an error signal provided by said fiber gain model.

6. A Raman module as claimed in claim 5, further comprising a gain estimating unit for providing, for each channel in said WDM signal, said estimated gain Gainₘₑₐₛ based on said respective predicted input power and said estimated output power.

7. A Raman module as claimed in claim 5, wherein said fiber gain model comprises:
a channel number estimating unit for estimating the current number k of channels in said WDM signal;
a spectrum estimating unit for assuming a spectral power and channel distribution in each said sub-band and providing an estimated sub-band power for each said sub-band; and
a comparator for comparing said measured sub-band power with said estimated sub-band power and providing said error signal.

8. A Raman amplifier as claimed in claim 7, wherein said spectrum estimating unit places said channels in random locations within the transmission band.

9. A Raman amplifier as claimed in claim 7, wherein said spectrum estimating unit places said channels in the middle of said transmission band.

10. A Raman amplifier as claimed in claim 5, wherein said input signal adjust unit recalculates said predicted input powers until said measured sub-band power and said estimated sub-band power are substantially equal.

11. A Raman amplifier as claimed in claim 5, wherein said spectrum estimating unit changes the estimated wavelength λ1 . . . λm of the channels in the respective sub-bands so as to minimize said error signal.

12. A Raman module as claimed in claim 4, wherein said sub-band performance parameter is a sub-band power.

13. A Raman module as claimed in claim 4, wherein said detecting unit comprises tap for separating a fraction of said WDM signal, a sub-band demultiplexer for demultiplexing said fraction into n sub-band signals and a monitor photodiode for each said sub-band signal for detecting a sub-band optical power P_{B1}, . . . P_{Bn} for each said sub-band signal.

14. A Raman module as claimed in claim 4, wherein said Raman pump unit comprises a pump block for generating a Raman pump signal and a pump controller for dynamically adjusting the power of said Raman pump signal according to said gain Gain_{RA}.

15. A Raman module as claimed in claim 14, wherein said pump block comprises a first pump assembly operating at a first wavelength and a second pump assembly operating at a second pump wavelength.

16. A Raman module as claimed in claim 15, wherein said pump controller further adjusts the ratio between the power of said first and second pump assemblies to equalize and minimize noise performance along the entire transmission band.

17. A Raman module as claimed in claim 14, wherein said pump block further comprises a third pump assembly which generates a third pump wavelength selected for obtaining a Raman gain graph with a substantially linearly tilted spectral shape.

18. A Raman module as claimed in claim 17, wherein said first pump wavelength is 1461 nm, said second pump wavelength is 1492 n and said third pump wavelength is in the spectral region between 1500 and 1520 nm.

19. A pump unit for a Raman module comprising a pump block with a first pump assembly operating at a first wavelength and a second pump assembly operating at a second pump wavelength for generating a WDM Raman pump signal and a pump controller for adjusting the power of each said Raman pump assembly according to a control signal.

20. A pump unit as claimed in claim 19, wherein said pump block further comprises a third pump assembly generating a third pump wavelength selected for obtaining a Raman gain graph with a substantially linearly tilted spectral shape.

21. A method of determining the spectrum of a WDM signal with a dynamic spectrum, comprising:
measuring n sub-band powers of said WDM signal at the output of a Raman module;
determining the number of channels in each said sub-band;
assuming a spectral distribution for said WDM signal, estimating an output power for each channel using a fiber gain model and calculating an estimated sub-band power for each said sub-band;
comparing said measured sub-band powers with said estimated sub-band powers to obtain an error signal; and
adjusting said spectral distribution to minimize said error signal.

22. A method as claimed in claim 21, wherein said step of adjusting comprises maintaining the wavelength of each channel unchanged and varying an assumed input power for each channel.

23. A method as claimed in claim 21, wherein said step of adjusting comprises maintaining an assumed input power for each channel unchanged and varying an assumed wavelength for each channel.

24. A method as claimed in claim 21, wherein a change in the number of channels in a sub-band results in re-distribution of said output power of each channel in said sub-band.

25. A method for controlling the gain of an optical WDM signal with a dynamic spectrum, said WDM signal traveling along a fiber link between two switching nodes of an agile network, comprising:
breaking said fiber link into gain controlled sections, and providing an optical amplifier at the egress side of each said section;
providing a spectral gain estimating unit at each said optical amplifier for determining the actual spectral gain for each section;
controlling a Raman pump at each said optical amplifier to adjust said actual spectral gain to a target gain,
wherein said target gain is substantially equal for all said sections of said fiber link.
